(19) United States
(12) Patent Application Publication
(10) Pub. No.: US 2007/0004475 A1
(43) Pub. Date: Jan. 4, 2007

(54) Mobile communication device

(75) Inventors: Chien-Chung Kuo, Taichung County (TW); Shin-Tai Lo, Miaoli County (TW); Chao-I Su, Taichung City (TW)

Correspondence Address: BACON & THOMAS, PLLC, 625 SLATERS LANE, FOURTH FLOOR, ALEXANDRIA, VA, 22314, US

(73) Assignee: Wintek Corporation, Taichung (TW)

(21) Appl. No.: 11/254,827

(22) Filed: Oct. 21, 2005

(30) Foreign Application Priority Data
Jul. 1, 2005 (TW) 94122441

(51) Int. Cl. H04M 1/00

(52) U.S. Cl. 455/575.3

(57) ABSTRACT

A mobile communication device includes an operating apparatus, a first base, a second base and a display. The operating apparatus has a phone interface on the body for input. A first base is disposed at the operating apparatus for open and close. The display is disposed at both of the first base and the second base. When the first base and the second base are opened (extended), the display is used to show information only. When the first base and the second base are closed (folded), the display on the second base is exposed to show the status of the mobile communication device.

### BACKGROUND OF THE INVENTION

1. Field of the Invention

The present invention relates generally to a mobile communication device, and more particularly to a mobile communication device capable of showing a great amount of information.

2. Description of the Related Art

FIG. 1 shows a conventional mobile phone 1, which has a phone body 10 to be held by user, on a front side 11 of which keys 12 and a screen 14 are provided. The mobile phone 1 is smaller in size that is convenient to user to carry it. Because a part area of the front side 11 is taken by the keys 12, the screen 14 is small in size such that it only shows a little amount of information with smaller characters or icons. Such mobile phone 1 cannot afford the requirements of accessing a great amount of information and facilitating users to read the information.

To overcome the drawbacks of the mobile phone 1, there is a folding mobile phone 2 presented in the market. As shown in FIG. 2 and FIG. 3, the folding mobile phone 2 has a phone body 20 and a phone base 22 pivoted on the phone body 20 to be closed and opened relative to the phone body 20. The phone body 20 has keys for input and operation. The phone base 22 is provided with a first screen 26 on an exterior side and a second screen 28 on an interior side. While the mobile phone 2 is folded and the system is in sleep, as shown in FIG. 2, the first screen 26 shows a few information, such as time, power and call mode. While the phone base 22 is opened and the system is awaked, as shown in FIG. 3, the second screen 28 with a size almost identical to the full area of the interior side of the phone base 22 shows a great amount of information with greater characters and icons.

Although the folding mobile phone has the second screen with greater size, the keys have a greater interval there between that takes too much space. On the contrary, if the interval between the keys is decreased to reduce the size of the mobile phone, the size of the second screen 28 is decreased also. In other word, the folding mobile phone cannot have both of the advantages of smaller size and bigger screen. In addition, because the first and second screens 26 and 28 are on opposite sides of the phone base 22, the first and second screens 26 and 28 will not show information simultaneously. Although the second screen 28 can show more information, but it still is not enough.

To overcome the above drawback, there is a mobile phone 3 with two screens and capable of showing information simultaneously. As shown in FIG. 4, the mobile phone 3 has two phone bases 30, 32 connected with each other, on each of which a screen 34, 36 is provided. The screens 34, 36 can show information simultaneously, except one of which is taken as the input interface when users operates the mobile phone 3. So, the screens 34, 36 cannot show information simultaneously when users operates the mobile phone 3. Only the input has done that the screens 34, 36 show information simultaneously. Such mobile phone 3 still has its drawback for improvement.

### SUMMARY OF THE INVENTION

The primary objective of the present invention is to provide a mobile communication device, which is small in size for portable and shows a great amount of information.

According to the objective of the present invention, a mobile communication device comprises an operating apparatus having a body and a phone interface on the body. A first base is stacked and pivoted on the body with a first coupling face facing the phone interface. A second base is stacked and pivoted on the first base with a second coupling face facing outwards. A flexible display is provided on both of the first base and the second base, wherein the flexible display has a first display region and a second display region, and the first display region is associated with the first coupling face of the first base and the second region is associated with the second coupling face of the second base. The display also may be two independent displays mounted on the first and second base respectively.

### BRIEF DESCRIPTION OF THE DRAWINGS

FIG. 1 is a perspective view of the conventional mobile phone with the screen and the keys on the same side;

FIG. 2 is a perspective view of the conventional folding mobile phone in sleep mode;

FIG. 3 is a perspective view of the conventional folding mobile phone in operative mode;

FIG. 4 is a perspective view of the conventional folding mobile phone with two screens for showing information simultaneously;

FIG. 5 is a lateral view of a first preferred embodiment of the present invention, showing the mobile communication device in operative mode;

FIG. 6 is a front view of the first preferred embodiment of the present invention, showing the mobile communication device in operative mode;

FIG. 7 is a lateral view of the first preferred embodiment of the present invention, showing the mobile communication device folded and in sleep mode;

FIG. 8 is a front view of a second preferred embodiment of the present invention, showing the mobile communication device in operative mode;

FIG. 9 is a lateral view of a third preferred embodiment of the present invention, showing the mobile communication device in operative mode;

FIG. 10 is a front view of the third preferred embodiment of the present invention, showing the mobile communication device in operative mode; and

FIG. 11 is a front view of a fourth preferred embodiment of the present invention, showing the mobile communication device in operative mode.

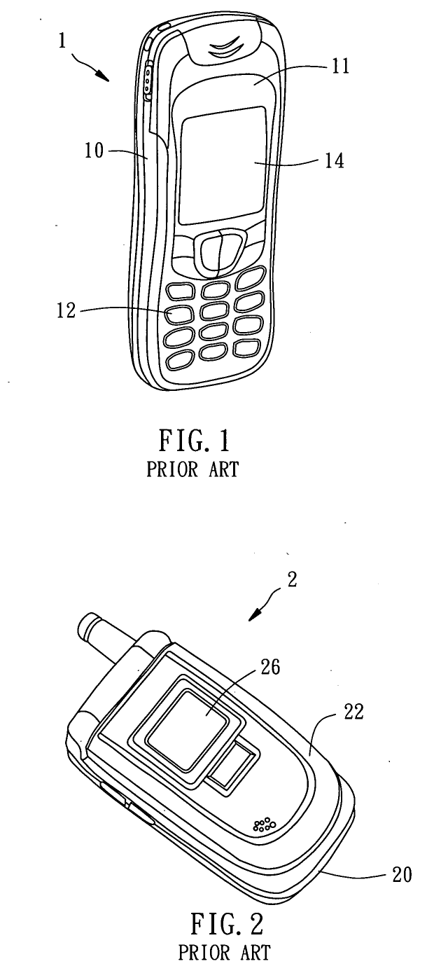

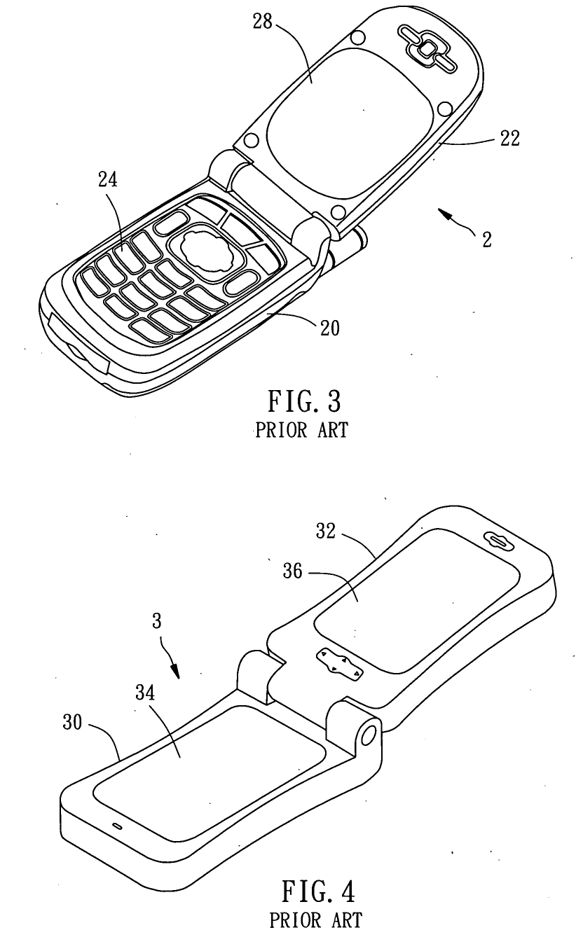

### DETAILED DESCRIPTION OF THE INVENTION

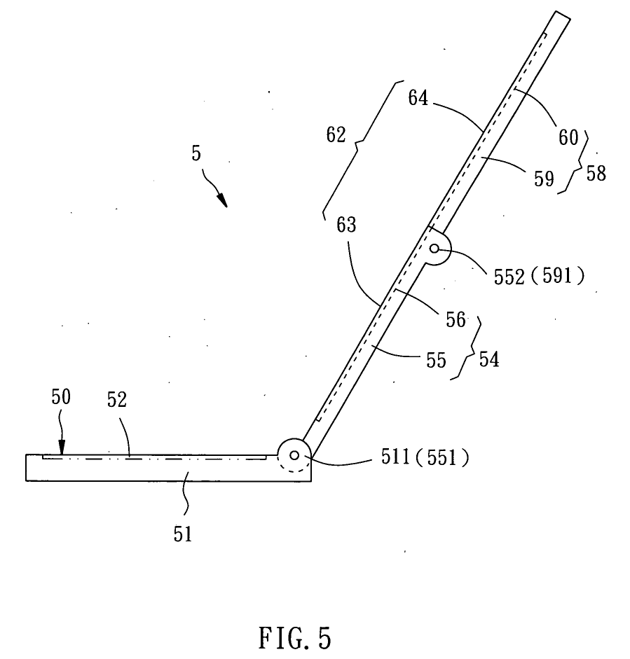

As shown in FIG. 5 to FIG. 7, a mobile communication device 5 of the first preferred embodiment of the present invention has an operating apparatus 50, a first base 54, a second base 58 and a flexible display 62.

The operating apparatus 50 has a body 51 to be held by user. The body 51 has a first connecting portion, which is two pivot bases 511 on a lateral end thereof, and a phone interface 52 on a front side thereof. The phone interface 52 may be a keypad or a touch screen for user to input messages or operate the device.

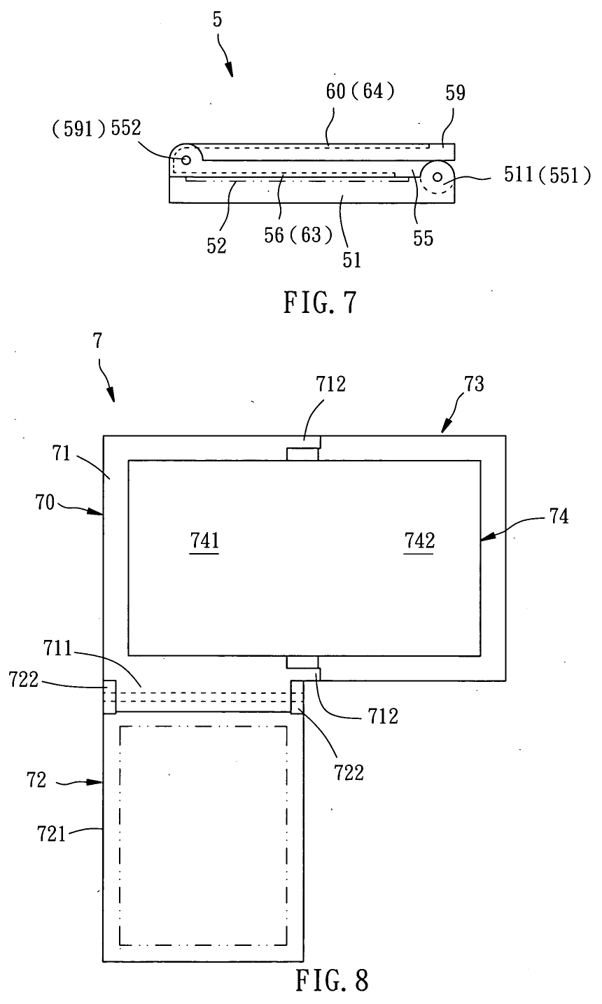

The first base 54 has a first case 55 and a first coupling face 56. The first case 55 has a first coupling portion, which is a block 551 on a side thereof. For assembly, the block 551 is put in between the pivot bases 511 and pivoted on the pivot bases 511, such that the first case 55 can be opened and closed relative to the body 51. As shown in FIG. 5, the first case 55 is opened, and FIG. 7 shows the first case 55 is stacked on the body 51. The first case 55 has a second connecting portion, which is two pivot bases 552 on a side opposite to the block 551. The first coupling face 56 is on a front side of the first case 55. As shown in FIG. 7, the first coupling face 56 faces the phone interface 52.

The second base 58 has a second case 59 and a second coupling face 60. The second case 59 has a second coupling portion, which is two blocks 591 on a side thereof. For assembly, the blocks 591 are engaged with the pivot bases 552 for pivot, such that the second case 59 can be opened and closed relative to the first case 55. As shown in FIG. 5, the second case 59 is opened, and FIG. 7 shows the second case 59 is stacked on the first case 55. The second coupling face 60 is on a front side of the second case 59. As shown in FIG. 5, the second coupling face 60 is connected to the first coupling face 56 along a longitudinal direction, and FIG. 7 shows the second coupling face 60 facing outwards.

The flexible display 62 is mounted on the first base 54 and the second base 58 with a size covering both of the first coupling face 56 of the first base 54 and the second coupling face 60 of the second base 58. The flexible display 62 has a first display region 63 associated with the first coupling face 56 and a second display region 64 associated with the second coupling face 60. The operating apparatus 50 operates both of the first and second display regions 63 and 64 to show information simultaneously or respectively. The flexible display 62 may be a flexible organic light emitting diode (FOLED), polymer light emitting diode (PLED), plastic liquid crystal display (PLCD), electronic paper (E-paper) or a display consisting of panels with flexible plastic substrates connected to each other by sealed less tiled technology.

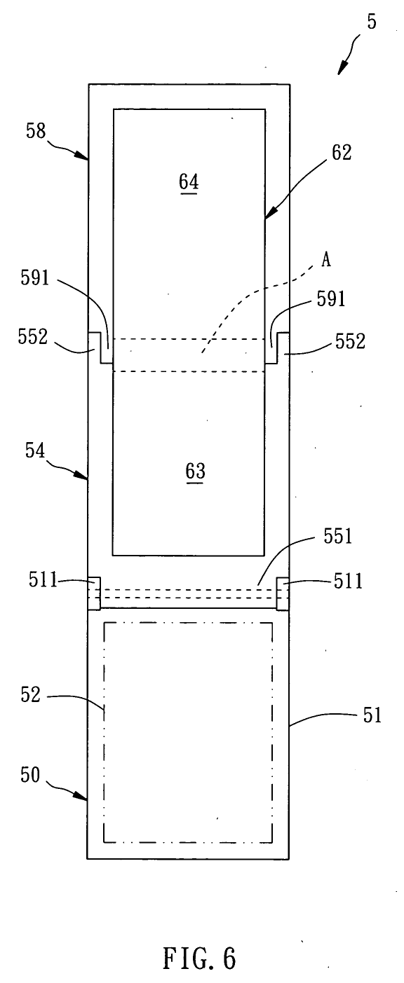

FIG. 6 shows the mobile communication device 5 in operative mode, which the first display region 63 and the second display region 64 of the display 62 are an integral along the longitudinal direction with a greater area to show a great amount information with large characters and icons such that the mobile communication device 5 may integrate electronic book and multi-media system efficiently to increase the value of the mobile communication device 5

While the second base 58 is extended outwards and attached on the first base 54, the first base 54 and the second base 58 are folded toward the operating apparatus 50 such that to fold the mobile communication device 5 of the present invention is in folding condition, as shown in FIG. 7, and the mobile communication device 5 will change to sleep mode in folding condition. In folding condition, the second display region 64 of the display 62 is on the exterior side to show information like time, power and call signal. The folding condition of the mobile communication device 5 of the present invention doesn't enlarge extra size to increase the value of the mobile communication device 5.

FIG. 8 shows a mobile communication device 7 of the second preferred embodiment of the present invention, which is similar to the mobile communication device 5 of the first preferred embodiment. The different parts of the mobile communication device 7 of the second preferred embodiment are described hereunder.

The mobile communication device 7 has a first base 70 with a case 71 and a first coupling portion, which is a block 711 on a side of the case 71, to be connected to two pivot bases 722 on a body 721 of an operating apparatus 72. The case 71 has a second connecting portion, which is two pivot bases 712 on a side opposite to the block 711, to be connected to a second base 73 for pivot. A display 74 is mounted on the first and second bases 70 and 73. While the second base 73 is opened relative to the first base 70, a first display region 741 and a second display region 742 of the display 74 are along a transverse direction.

It has to be mentioned here that the mobile communication device 5 (7), as shown in FIG. 6 or FIG. 8, has the display 62 (74) with the integral first and second display regions 63 (741) and 64 (742). As shown in FIG. 6, the mobile communication device 5 has a hollow portion “A” between the first case 55 and second case 59 to comprehend the tensile problem of the display 62 when the second base 58 is folded relative to the first base 54.

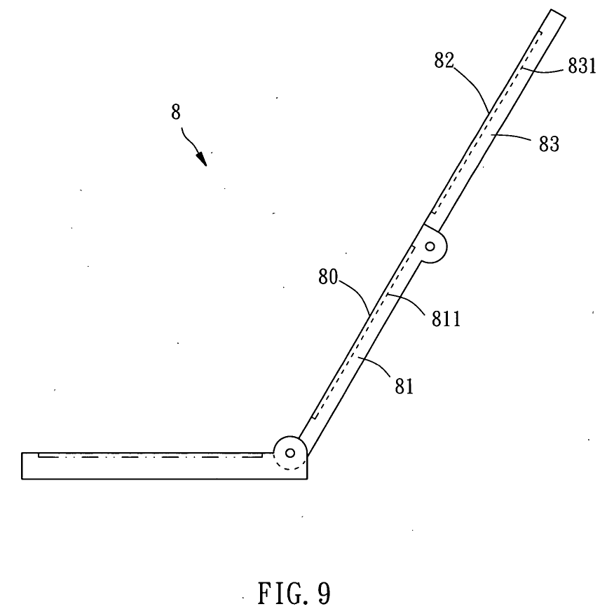

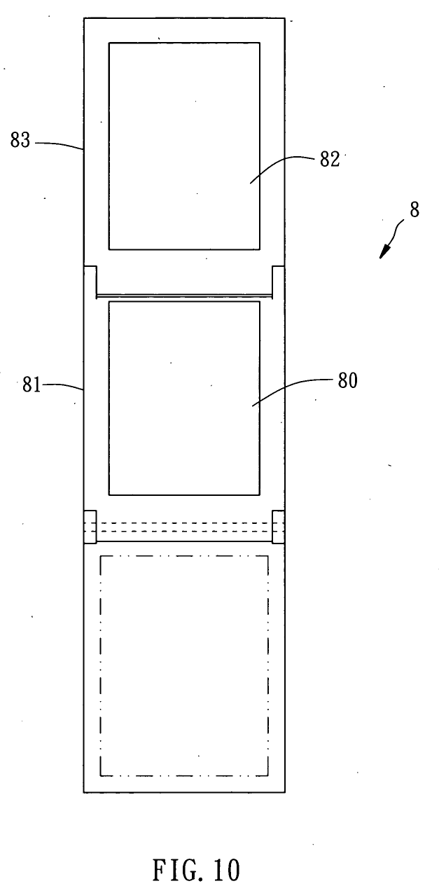

FIG. 9 and FIG. 10 shows a mobile communication device 8 of the third preferred embodiment of the present invention, which is similar to the mobile communication device 5 of the first preferred embodiment, except that the mobile communication device 8 has a first display 80 and a second display 82 to achieve the function of showing a great amount of information. The mobile communication device 8 has a first base 81 with a first coupling face 811, on which the first display 80 is mounted, and a second base 83 with a second coupling face 831, on which the second display 83 is mounted. The first and second displays 80 and 82 may show information simultaneously or respectively.

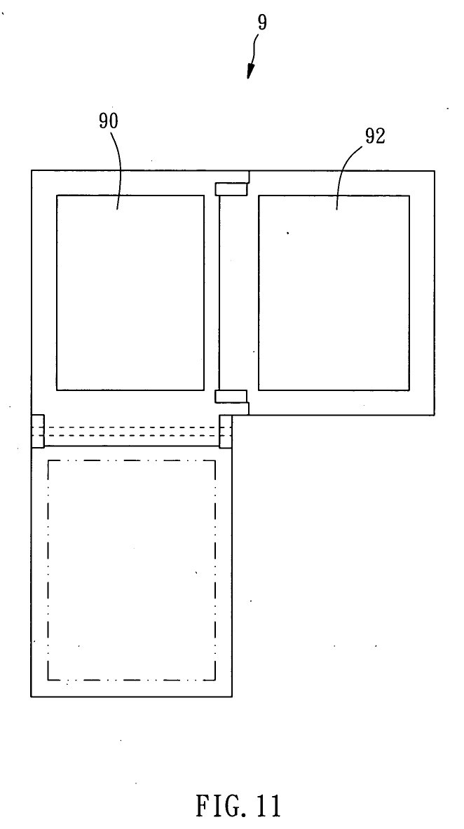

FIG. 11 shows a mobile communication device 9 of the fourth embodiment of the present invention, which is similar to the mobile communication device 7 of the second preferred embodiment. The different parts are described hereunder.

The mobile communication device 7 of the second preferred embodiment has the single display to be the interface of showing a great amount of information, but the mobile communication device 9 of the fourth embodiment has a first display 90 and a second display 92 to achieve the function of showing a great amount of information. The first and second displays 90 and 92 may show information simultaneously when the mobile communication device 9 is in operative mode. The second display 92 shows independent information when the mobile communication device 9 is in sleep mode.

The first display and second display of the mobile communication device of the third and fourth embodiment of the present invention may not be the flexible displays because they are separated. The liquid crystal display with glass substrate may be used for the first display and second displays.

The description above only includes four preferred embodiment and the equivalence of the present invention is still in the scope of the claim of the present invention.

What is claimed is:

1. A mobile communication device, comprising:
an operating apparatus having a body and a phone interface on the body;
a first base stacked and pivoted on the body with a first coupling face facing the phone interface;
a second base stacked and pivoted on the first base with a second coupling face facing outwards; and
a flexible display provided on both of the first base and the second base, the flexible display has a first display region and a second display region, and the first display region is associated with the first coupling face of the first base and the second region is associated with the second coupling face of the second base.

2. The mobile communication device as defined in claim 1, wherein the body of the operating apparatus has a first connecting portion, and the first base has a first case with a first coupling portion and a second connecting portion, wherein the first coupling portion pivots the first connecting portion, and the second base has a second case with a second coupling to pivot the second connecting portion.

3. The mobile communication device as defined in claim 2, wherein the first coupling portion is provided on an end of the first case facing the body, and the second connecting portion is on an end of the first case opposite to the first coupling portion, and the second connecting portion pivots the second coupling portion of the second case to connect the first display region and the second display region of the display along a longitudinal direction.

4. The mobile communication device as defined in claim 2, wherein the first coupling portion is provided on an end of the first case facing the body, and the second connecting portion is on a side of the first case adjacent to the first coupling portion, and the second connecting portion pivots the second coupling portion of the second case to connect the first display region and the second display region of the display along a transverse direction.

5. The mobile communication device as defined in claim 2, wherein the first connecting portion of the operating apparatus has two pivot bases, and the first coupling portion of the first base has a block rested between the pivot bases for pivot.

6. The mobile communication device as defined in claim 2, wherein the second connecting portion has two pivot bases, and the second coupling portion of the second base has two blocks to pivot the pivot bases respectively.

7. A mobile communication device, comprising:
an operating apparatus having a body and a phone interface on the body;
a first base stacked and pivoted on the body with a first coupling face facing the phone interface;
a second base stacked and pivoted on the first base with a second coupling face facing outwards;
a first display disposed at the first coupling face of the first base; and
a second display disposed at the second coupling face of the second base.

8. The mobile communication device as defined in claim 7, wherein the body of the operating apparatus has a first connecting portion, and the first base has a first case with a first coupling portion and a second connecting portion, the first coupling portion pivots the first connecting portion, and the second base has a second case with a second coupling to pivot the second connecting portion.

9. The mobile communication device as defined in claim 8, wherein the first coupling portion is disposed at an end of the first case facing the body, and the second connecting portion is on an end of the first case opposite to the first coupling portion, and the second connecting portion pivots the second coupling portion of the second case to connect the first display and the second display along a longitudinal direction.

10. The mobile communication device as defined in claim 8, wherein the first coupling portion is disposed at an end of the first case facing the body, and the second connecting portion is on a side of the first case adjacent to the first coupling portion, and the second connecting portion pivots the second coupling portion of the second case to connect the first display and the second display along a transverse direction.

11. The mobile communication device as defined in claim 8, wherein the first connecting portion of the operating apparatus has two pivot bases, and the first coupling portion of the first base has a block rested between the pivot bases for pivot.

12. The mobile communication device as defined in claim 8, wherein the second connecting portion has two pivot bases, and the second coupling portion of the second base has two blocks to pivot the pivot bases respectively.
